(19) United States
(12) Patent Application Publication
(10) Pub. No.: US 2025/0001923 A1
(43) Pub. Date: Jan. 2, 2025

(54) VEHICLE CENTRE CONSOLE TABLE SYSTEM

(71) Applicant: JAGUAR LAND ROVER LIMITED, Whitley, Coventry, Warwickshire (GB)

(72) Inventors: Philip MATTINSLEY, Whitley, Coventry, Warwickshire (GB); Alexander GRAY, Whitley, Coventry, Warwickshire (GB)

(21) Appl. No.: 18/701,896

(22) PCT Filed: Oct. 12, 2022
(86) PCT No.: PCT/EP2022/078434

§ 371 Date: Apr. 16, 2024

(30) Foreign Application Priority Data
Oct. 22, 2021 (GB) 2115173.3

(51) Int. Cl. B60N 3/00

(52) U.S. Cl. CPC B60N 3/001

(57) ABSTRACT

A vehicle centre console table system includes: a table; and a slider arrangement configured to enable horizontal sliding of the table from a first position to a second position horizontally offset from the first position; wherein the slider arrangement is configured to prevent horizontal rotation of the table when the table is not in the second position and configured to permit horizontal rotation of the table when the table is in the second position.

### TECHNICAL FIELD

The present disclosure relates to a vehicle centre console table system. In particular, but not exclusively it relates to a vehicle centre console table system for a vehicle rear centre console, and relates to a vehicle rear centre console, and relates to a vehicle.

### BACKGROUND

It is known for vehicles comprising multiple rows of seats to comprise seat back-mounted tables for rear seat occupants. A limitation of seat back-mounted tables is that the front seat supporting the table is slidable backwards and forwards, resulting in undesirable movement of the table for the rear-seated occupant.

A table supported at another, fixed location in the vehicle may require multiple different joints to enable the table to be positioned in front of the user. The joints may enable the table to pivot about at least two different axes. Each joint may have a degree of lost motion associated therewith. The table and its mechanisms also require a large volume of packaging space.

It is an aim of the present invention to address one or more of the disadvantages associated with the prior art.

### SUMMARY OF THE INVENTION

Aspects and embodiments of the invention provide a vehicle centre console table system, a vehicle centre console, a vehicle, etc., as claimed in the appended claims.

According to an aspect of the invention there is provided a vehicle centre console table system, the vehicle centre console table system comprising: a table; a slider arrangement configured to enable horizontal sliding of the table from a first position to a second position horizontally offset from the first position; wherein the slider arrangement is configured to prevent horizontal rotation of the table when the table is not in the second position and configured to permit horizontal rotation of the table when the table is in the second position. An advantage is that this enables the table to be slid towards a user, and then rotated towards the user, for improved ease of use. As the table can only be rotated when it has moved towards the user, rotation of the table is prevented when the table is in a position such that contact may occur with other components of the vehicle, such as the front seats.

The slider arrangement may comprise: a longitudinal guide arranged on a longitudinal axis of the vehicle centre console table system and comprising a first longitudinal guide end and a second longitudinal guide end. The slider arrangement may comprise a transverse guide arranged transverse to the longitudinal axis and comprising a first transverse guide end to a first side of the longitudinal guide and a second transverse guide end to a second side of the first guide, wherein the transverse guide enables horizontal rotation of the table between the first transverse guide end and the second transverse guide end while the table is at the second position. The slider arrangement may comprises an intersection between the longitudinal guide and the transverse guide at the first longitudinal guide end of the longitudinal guide. An advantage is that the slider arrangement is easy to manufacture, whilst providing a robust and reliable rotational interlock for the table. At least in certain embodiments, the vehicle centre console table system comprises a deployable table. The vehicle centre console table system comprises a rotational table interlock for controlling rotation of the table. The slider arrangement may form the rotational table interlock. The transverse guide may comprise a curve to enable the horizontal rotation of the table. An advantage is that the rotation of the table is defined by this curve.

The vehicle centre console table system may comprise a first guide member configured to interface with the longitudinal guide and the transverse guide, wherein the first guide member and the longitudinal guide are slidable relative to each other. The first guide member may be able to transition to the transverse guide when the table reaches the second position so that the first guide member and the transverse guide are slidable relative to each other to enable the horizontal rotation of the table. The vehicle centre console table system may comprise a second guide member configured to interface with the longitudinal guide wherein the second guide member and the longitudinal guide are slidable relative to each other, wherein a location of the second guide member defines a vertical axis about which the table is rotatable when the table is in the second position. Rotation of the table around the vertical axis may be constrained within an angular range based on the first transverse guide endand the second transverse guide end. For example, in one embodiment, the angular range may be a value selected from the range between −30° and +30°.

An advantage is that the permitted degree of sliding and rotation of the table may be defined, whilst using a low number of parts. The permitted degree of sliding an rotation is also easily adaptable, by for example, changing the geometry of the longitudinal guide and/or transverse guide. Thus, the same basis design principle may be easily adapted to different vehicle installations, in which the space constraints for table movement and rotation may differ.

The vehicle centre console table system may comprise a detent arrangement configured to hold the table in at least one orientation within the angular range. The detent arrangement may comprise a plurality of detent positions.

An advantage is that when the table has been slid rearwards, it may be rotated to one of several orientations, corresponding to orientations which are convenient for use of the table by a user. Once at one of these positions, the table is held in this orientation by the detent. This is advantageous because the table would otherwise rotate as the vehicle in which it was fitted changed speed and/or direction. Such unintentional rotation would be detrimental to the user's experience.

The detent arrangement may comprises a ball, a bias and a socket, wherein the bias provides a force to locate the ball within the socket.

An advantage is that the detent is automatic in operation. No further user intervention (for example, fastening a clamping arrangement) is required by the user, once the table has been rotated to its desired orientation.

In some embodiments, the first guide member comprises the ball and the bias.

An advantage is case of manufacture due to a reduced parts count. This is because the first guide member is multi-functional, as it acts to both control sliding and rotation of the table, whilst providing a detent to prevent table rotation once the table has been rotated to its desired orientation.

According to an aspect of the invention that is provided a vehicle centre console comprising the vehicle centre console table system.

According to an aspect of the invention there is provided a vehicle comprising the vehicle centre console table system or the vehicle centre console.

Within the scope of this application it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 illustrates an example of a vehicle centre console table system comprising a table at a retracted position;

FIG. 3 illustrates an example in which the table has been raised to a first position;

FIG. 4 illustrates an example in which the table has been moved to a second position;

FIG. 5 illustrates an example in which deployable leaves of the table have been deployed;

FIG. 6 illustrates an example in which the table has been turned to a first operating angle;

FIG. 7 illustrates an example in which the table has been turned to a second operating angle;

FIG. 8 illustrates an example of an actuation system;

FIG. 9 schematically illustrates an example of a slider arrangement;

FIG. 10 schematically illustrates an example of the slider and a pivot;

FIG. 11 schematically illustrates an example of a hinge for a table leave;

FIG. 12A schematically illustrates an example of an interlock comprising a locking block, which is slidable between a locking position and an unlocking position, wherein the locking block is shown at the locking position;

FIG. 12B schematically illustrates an example of the interlock comprising the locking block, wherein the locking block is shown at the unlocking position;

FIG. 13A schematically illustrates an actuation system, comprising a lever, when a locking block is at a locking position; and

FIG. 13B schematically illustrates an actuation system, comprising a lever, when a locking block is at an unlocking position;

FIG. 14A schematically illustrates a second view of the interlock comprising the locking block, wherein the locking block is shown at the locking position;

FIG. 14B schematically illustrates a second view of the interlock comprising the locking block, wherein the locking block is shown at the unlocking position.

### DETAILED DESCRIPTION

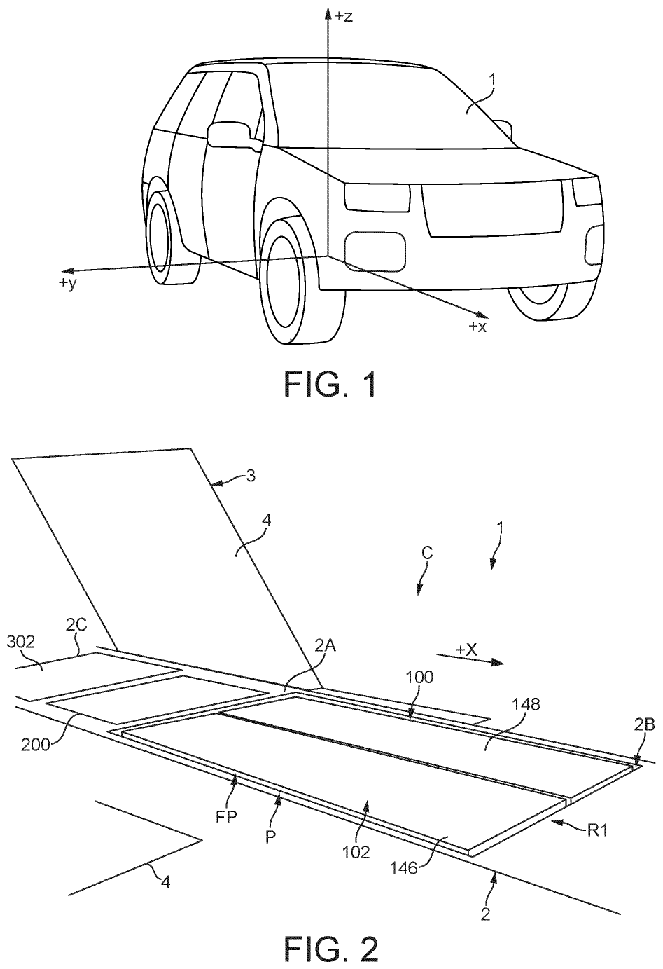

FIG. 1 illustrates an example of a vehicle 1 in which embodiments of the invention can be implemented. In some, but not necessarily all examples, the vehicle 1 is a passenger vehicle, also referred to as a passenger car or as an automobile. In other examples, embodiments of the invention can be implemented for other applications, such as commercial vehicles.

FIG. 1 is a front perspective view and illustrates a longitudinal x-axis between the front and rear of the vehicle 1 representing a centreline, an orthogonal lateral y-axis between left and right lateral sides of the vehicle 1, and a vertical z-axis. A forward/fore direction typically faced by a driver's seat is in the positive x-direction; rearward/aft is-x. A rightward direction as seen from the driver's seat is in the positive y-direction; leftward is-y. These are a first lateral direction and a second lateral direction.

FIG. 2 schematically illustrates an example of a vehicle centre console 2 in front perspective view. The vehicle centre console 2 can be located between seats 4 in a row 3 of seats 4 of the vehicle 1. The vehicle centre console 2 may extend along the x-axis. The vehicle centre console 2 may extend along a centreline of the vehicle 1. In some examples, the row 3 of seats 4 is other than a front row of seats of the vehicle 1 comprising a driver's seat. The row 3 of seats 4 may be aft of another row of seats of the vehicle 1. For example, the row 3 of seats 4 may comprise a first rear row of seats 4 or (if present) a second rear row of seats 4. Optionally, the vehicle centre console 2 extends between the seats 4 in lieu of a centre seat.

The vehicle centre console 2 comprises various accessories for the convenience of occupants of those seats 4. An upper surface of the vehicle centre console 2 can comprise sections (e.g., openings) for receiving the various accessories during assembly. The vehicle centre console 2 can comprise a table system section/opening 2B for the installation of a vehicle centre console table system 100 (‘table system’ herein). In some examples, the vehicle centre console 2 can further comprise a user input device section/opening 2C for the installation of a user input device 302 such as a touchscreen display. The user input device 302 may be located aft of the table system 100 and opening 2B, as shown in FIG. 2, so is convenient to reach from the seats 4. In some examples, the vehicle centre console 2 can further comprise a cupholder system 200. The cupholder system 200 may be located aft of the table system 100 and opening 2B.

The features of the table system 100 will now be described. FIGS. 2-7 illustrate the table system 100. The table system 100 comprises a movable apparatus comprising a table 102 movable from a retracted position R1 to a first position P1 elevated above the retracted position R1. The table 102 can then be reconfigured via one or more movable table joints. The table 102 can be slid from the first position P1 to a second position P2 horizontally offset from the first position. When installed in a vehicle 1, the second position P2, horizontally offset from the first position, is an aft position rearward of the first position P1. The table 102 can then be turned from the second position P2 to another horizontal angle if desired by the user. The table 102 is pivotable horizontally from the second position P2, between a first operating angle A1 and a second operating angle A2. When installed in a vehicle 1, the first operating angle A1 is facing a left seat 4 and the second operating angle A2 is facing a right seat 4. Deployable leaves 146, 148 of the table 102 can be opened out.

An advantage of the ability to deploy the table 102 rearwards and then reposition the table 102 is that the table 102 can be stowed in a relatively forward position on the vehicle centre console 2, without the possibility of interference between the table 102 and front seats. This enables other equipment such as the user input device 302 and cupholder system 200 to be located aft of the retracted table 102 within convenient reach of the seat occupants.

FIG. 2 illustrates the table 102 in the retracted position R1. In the retracted position R1, the table 102 is in a substantially horizontal orientation. The table 102 is usable by occupants of the row 3 of seats 4. Occupants can lean forward and place items on a surface of the table 102.

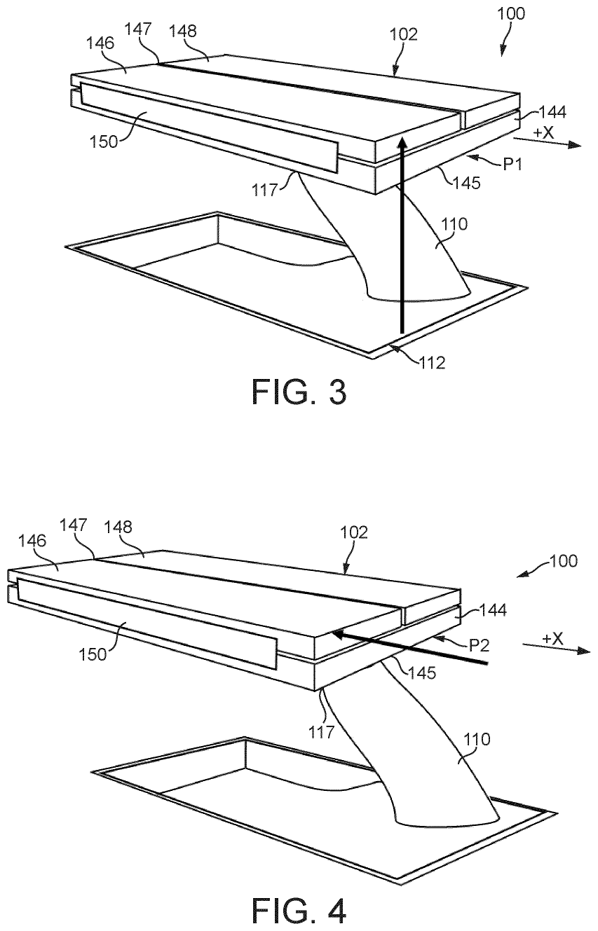

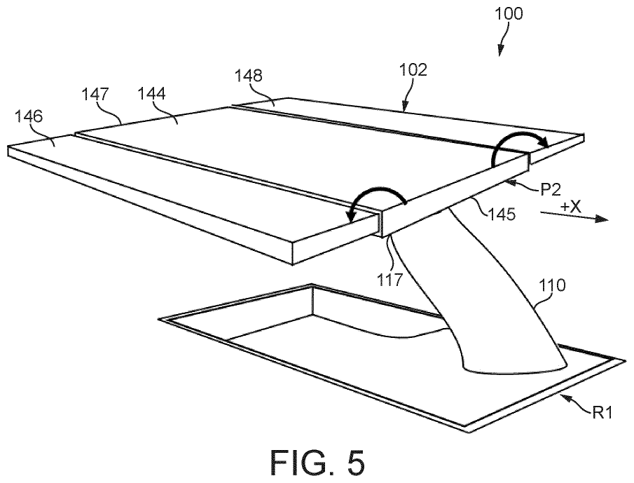

In the example illustrated in the Figures, the table 102 comprises a table body 144 (main body, visible in FIG. 3) and deployable leaves 146, 148 (secondary bodies) to increase a surface area of the table 102 when deployed to an open configuration. The deployable leaves 146, 148 may be deployable to increase a width (y-axis) of the table 102 when deployed. This is desirable because the table body 144 may have a narrow width (e.g., less than its x-axis length), to fit within the narrow vehicle centre console 2. When the deployable leaves 146, 148 are in the deployed configuration (FIG. 5, 6), the width of the table 102 (including body and leaves 144, 146, 148) is greater than the width of the vehicle centre console 2.

The illustrated deployable leaves 146, 148 comprise a first leaf 146 connected to a first side of the table body 144, and a second leaf 148 connected to a second, opposite side of the table body 144. When the table 102 is in the retracted position R1, the deployable leaves 146, 148 are in a stowed (closed), folded configuration so that the plan view width of the table 102 is less than the plan view width of the vehicle centre console 2.

The deployable leaves 146, 148 may be hinged such that the deployable leaves 146, 148 are folded on top of the table body 144 when in the stowed configuration. An example double hinge 150 for a leaf 146 is shown in FIG. 11. The double hinge 150 comprises a first hinge axis 152 and a second hinge axis 154, parallel to the first hinge axis 152. The double hinge 150 may comprise a hinge body 156 through which the first and second hinge axes 152, 154 extend. As described later, the first hinge axis 152 and second hinge axis 154 permit rotation of the deployable leaves 146,148 relative to the table body 144. The hinge body 156 may rotate about both the first hinge axis 152 and the second hinge axis 154. It would be appreciated that the deployable leaves 146, 148 could be deployable in a different manner than that shown.

In FIG. 2, the deployable leaves 146, 148 are in the stowed configuration and the table 102 is in the retracted position R1. The hinged deployable leaves 146, 148 are upside down in the stowed configuration, so their undersides face upwards. The undersides comprise substantially horizontal surfaces so that items can be placed thereon. The upwardly-facing undersides of the deployable leaves 146, 148 are at the flush position FP on the first plane P. The table body 144 may be concealed beneath the deployable leaves 146, 148. The average width of each leaf 146, 148 may be approximately half the width of the table body 144, so that when the deployable leaves 146, 148 are folded closed the first and second leaves 146, 148 meet at a central border/gap. The sum of the plan view areas of the deployable leaves 146, 148 may be approximately equal to the plan view area of the table body 144. Hence, when in the stowed configuration, the leaves 146, 148 at least partially cover the table body.

FIG. 3 illustrates the table 102 at a first position P1 elevated above the retracted position R1.

The table 102 can be activated automatically, i.e., without user intervention, to move between the retracted position R1 and the first position P1, in response to a user-initiated request. In FIG. 3, the deployable leaves 146, 148 are still in the closed configuration. The table 102 is still facing the x-axis and has not been turned. This is to prevent interference between the table 102 and seat backs of front seats of the vehicle 1. Interlocks 160, 260 (described later) can be provided. A sensor (not described) may be provided to detect when the table 102 is at the first position P1. The sensor may be configured to only permit the table 102 to be retracted to the retracted position R1 when the table is at first position P1. This has the advantage that the table may not be retracted when it is rearward of P1, as to do so would risk contact between an underside of the table and other surfaces of the vehicle centre console table system or interior trim of the vehicle, risking damage.

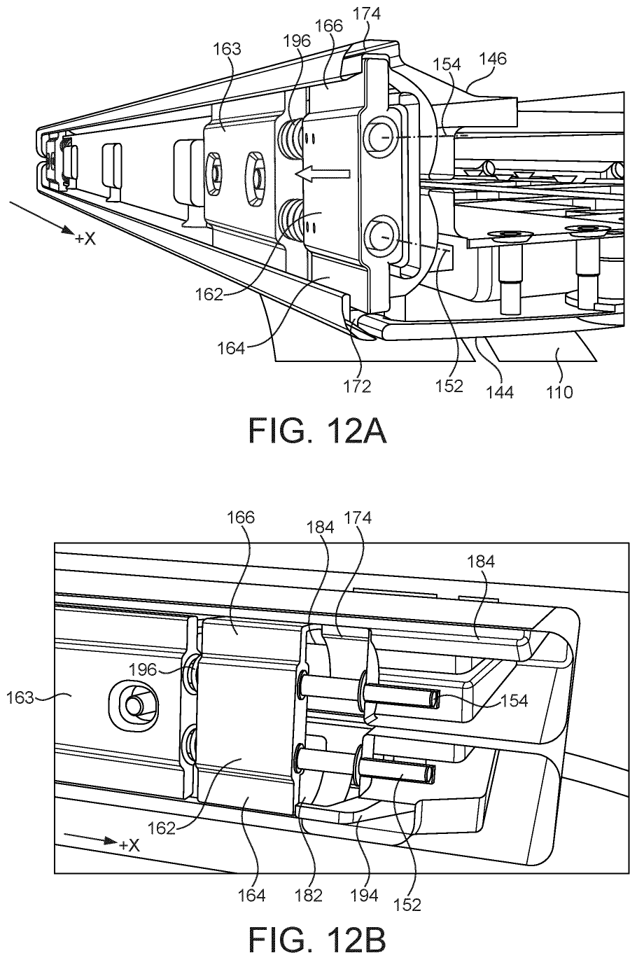

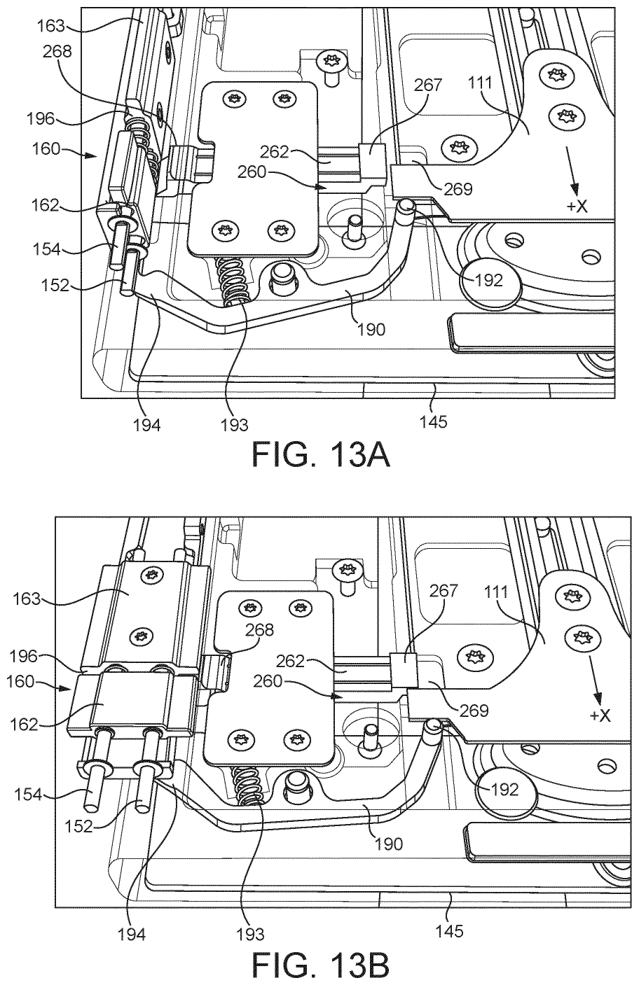

An interlock 160 (FIGS. 12A, 12B, 13A, 13B) may be provided, the interlock 160 being configured to prevent rotation of the at least one table leaf 146, 148 relative to the table body 144 when the table body 144 is at the first position P1, and configured to permit rotation of the at least one table leaf 146, 148 relative to the table body 144 when the table body 144 is in the second position P2 horizontally offset from the first position P1. In other words, the interlock 160 requires the table 102 to be slid rearwards from the first position P1 to the second position P2, horizontally offset from the first position P1 before the deployable leaves 146, 148 can move to their open configuration and/or before the table 102 can be turned to the first operating angle A1 or to the second operating angle A2. This provides the advantage that, when installed in a vehicle 1, the table leaves 146, 148 cannot be deployed when there is a possibility of contact between the table leaves and the backs of the front seats.

A second interlock 260 may be provided, the second interlock 260 being configured to prevent horizontal sliding of the table body from the second position P2 to the first position P1 when the at least one table leaf is in the deployed position. In other words, the second interlock 260 requires the table leaves 146, 148 to be stowed before the table 102, comprising the table body 144, can slide from the second position P2 to the first position P1. This provides the advantage that, when installed in a vehicle 1, the table cannot be moved forward with the table leaves 146, 148 deployed, as this could cause potential contact and/or damage to the deployed leaves and backs of the front seats. The interlock 160 and the second interlock 260 are described in detail in later sections.

FIG. 3 illustrates a support 110 beneath the table 102, through which a load path from the table 102 towards the vehicle body is transferred. The support 110 can comprise at least one strut. The support 110 may be solid or hollow. The illustrated support 110 comprises a single strut (arm). The table 102 may be cantilevered from the support 110.

FIG. 4 illustrates the table 102 at a second position P2, horizontally offset from the first position P1, having been slid rearward using a slider arrangement 106. The slider arrangement 106 is configured to enable horizontal sliding of the table 102 from the first position P1 to the second position P2. The slider arrangement 106 is configured to prevent horizontal rotation of the table when the table is not in the second position and configured to permit horizontal rotation of the table when the table is in the second position. The second position P2 may be a position at which the slider arrangement 106 has reached a limit of travel.

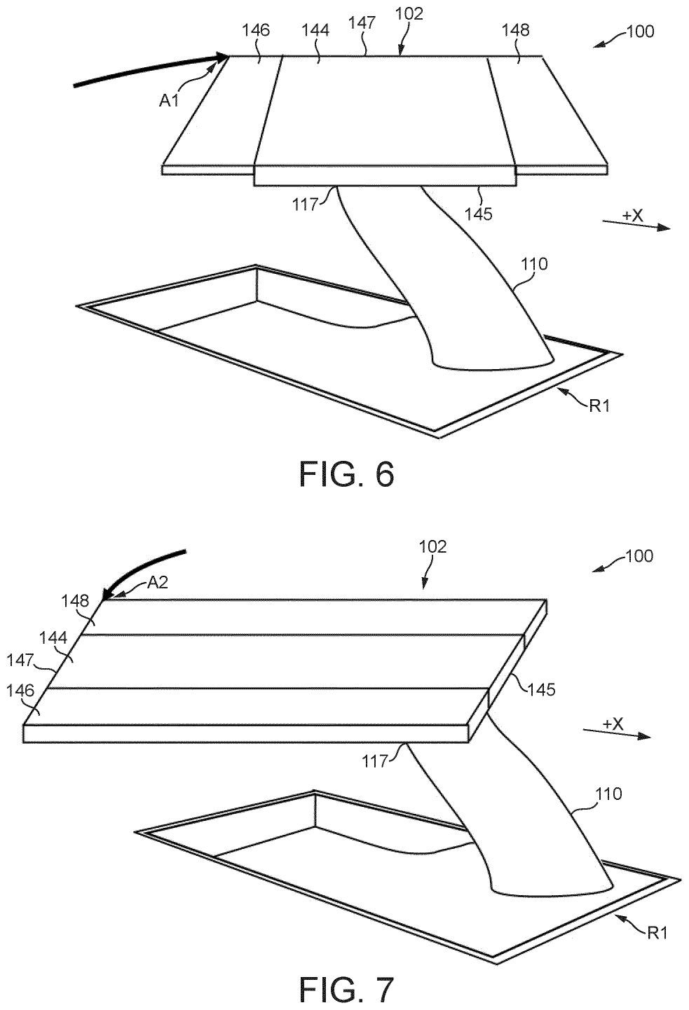

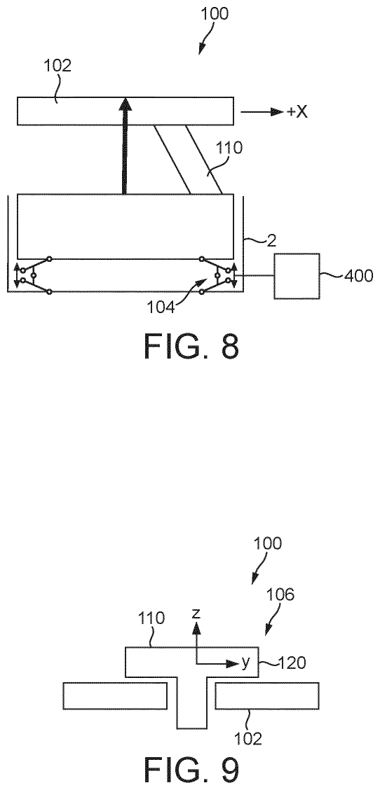

The second position P2 may be at substantially the same height as the first position P1. The second position P2 may be in the substantially horizontal orientation. The aft edge of the table 102 is aft of the table system opening 2B. The aft edge 147 of the table 102 at the second position P2 may now be above the cupholder system 200 and/or the user input device 302. The table 102 at the second position P2 is clear of the seat backs of the front seats so the hinged deployable leaves 146, 148 can now be rotated to the open configuration (FIG. 5) and/or the table 102 can now be turned relative to the z-axis to face left or right (FIGS. 6, 7).

The sliding of the table 102 relative to a top 117 of the support 110 means that the top 117 of the support 110 is now closer to the fore edge 145 of the table 102. Therefore, the cantilevered span of the table 102 is greater.

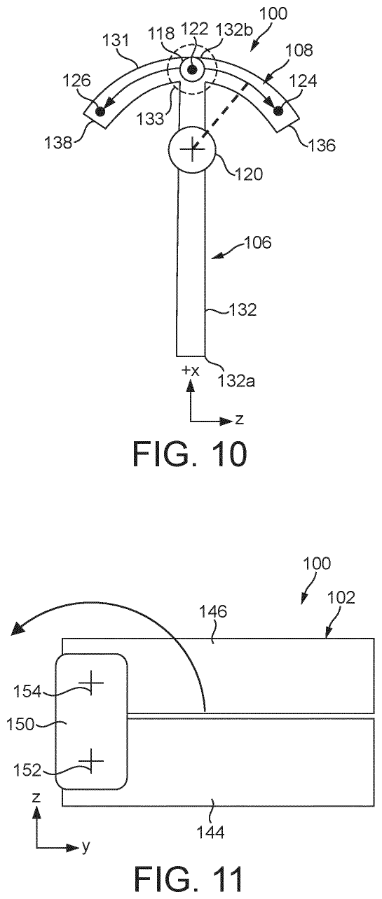

FIG. 10 schematically illustrates a plan view of the example slider arrangement 106. The example slider arrangement 106 comprises a longitudinal guide 132, arranged on a longitudinal axis of the vehicle centre console table system 100. Longitudinal guide 132 may comprise a slot within which one or more guide members 118, 120 is/are constrained. The longitudinal guide 132 has a first longitudinal guide end 132a and a second longitudinal guide end 132b. The first longitudinal guide end 132a and second longitudinal guide end 132b may be horizontally and longitudinally offset from each other. When installed in a vehicle 1, the second longitudinal guide end 132b is forward of the first longitudinal guide end 132a.

In the illustrated example, the table 102 comprises the longitudinal guide 132 and the support 110 comprises the first and/or second guide members 118, 120. Therefore, as the table 102 is moved, the longitudinal guide 132 moves relative to the static guide members 118, 120. In another implementation, the support 110 comprises the longitudinal guide 132 and the table 102 comprises the first and/or second guide members 118,120, so that at least the second guide member 120 moves within the static longitudinal guide 132.

The slider arrangement 106 is configured to enable horizontal sliding of the table from the first position P1 to the second position P2, horizontally offset from the first position P1. The slider arrangement 106 is also configured to prevent horizontal rotation of the table 102, when the table 102 is not in the second position P2 (i.e., an aft position when installed in a vehicle 1) and is configured to permit horizontal rotation of the table when the table is in the second position P2. The slider arrangement 106 now described therefore forms a sliding and rotational table interlock for the vehicle centre console table system 100. The slider arrangement 106 may comprise a detent 122 configured to engage when the table 102 reaches the second position P2. The detent 122 further increases the stability of the table 102, for example by resisting unintended sliding and/or turning out of the second position P2.

FIG. 10 illustrates an example location of the detent 122. The detent 122 may comprise a biased plug and a socket. The plug may be a rounded article such as a ball. The bias may comprise a spring. The socket may comprise a blind hole into which the plug is biased. The rounded shape of the plug enables the detent 122 to be disengaged by horizontal force even though bias force is applied in a vertical direction. In one implementation, the support 110 comprises the plug and the underside of the table body 144 comprises the socket. In another implementation, the underside of the table body 144 comprises the plug and the support 110 comprises the socket.

FIG. 10 also illustrates an example implementation of a pivot 108 configured to enable turning of the table 102 along a horizontal arc, in clockwise and anti-clockwise directions, between the first operating angle A1 (facing a left seat 4, FIG. 6) and a second operating angle A2 (facing a right seat 4, FIG. 7). The pivot 108 may enable manual turning of the table 102 by hand.

The second guide member 120 may be part of a rotatable joint, rotatable about a vertical axis (z-axis). The table 102 is rotatable about the vertical axis defined by the second guide member 120 when the table is in the second position. The rotation of the table around the vertical axis may be constrained within an angular range, for example determined by the first transverse guide end 136. For example, the angular range may be a value selected from the range between −30° and +30°.

The slider arrangement 106 also comprises a transverse guide 131, that is arranged transverse to the longitudinal axis of the longitudinal guide 132. The transverse guide 131 is configured to enable the horizontal rotation of the table between the first transverse guide end 136 and the second transverse guide end 138 while the table is at the second position P2. The transverse guide may comprise a slot. The transverse guide 131 has a first transverse guide end 136, on a first side of the longitudinal guide 132, and a second transverse guide end 138, on a second side of the longitudinal guide 132. The transverse guide 131 and the longitudinal guide 132 may intersect at an intersection 133. The intersection 133 between the transverse guide 131 and the longitudinal guide 132, may be at the first longitudinal guide end 132b of the longitudinal guide. The first guide member 118 may be configured to transition between the longitudinal guide 132 and the transverse guide 131. The detent 122 may be located at the intersection 133 between the longitudinal guide 132 and the transverse guide 131.

The transverse guide 131 is in the same plane as the longitudinal guide 132 and is mounted to the same body as the longitudinal guide 132. FIG. 10 illustrates a single T-slot comprising the longitudinal guide slot 132 and the transverse guide slot 131 which meet at the intersection 133. In some, but not necessarily all embodiments, the transverse guide 131 may be symmetrical about the longitudinal axis of the longitudinal guide slot 132. This means that the degree of rotation of the table 102 towards a user in the vehicle 1 may be equal, irrespective of which rear seat the user occupies. The transverse guide slot 131 is configured to constrain the first guide member 118. The first guide member 118 is mounted to the same body as the second guide member 120. In one embodiment, the transverse guide 131 is curved and the first guide member 118 is separated from the second guide member 120 in the x-direction by a distance corresponding to a radius which is the same as the radius of curvature of the transverse guide slot 131. The second guide member 120 is therefore located at the centre of curvature of the pivot. The curve in the transverse guide 131 may enable the horizontal rotation of the table. When the table 102 is not at the second position P2, the slider arrangement 106 comprises one degree of freedom of translation to enable sliding in the +/−x-direction between the first position P1 and the second position P2. The slider comprises one degree of freedom of translation because both the first guide member 118 and the second guide member 120 are constrained to slide along the axis of the longitudinal guide slot 132.

When the table 102 is at the second position P2, the second guide member 120 is located at the centre of curvature of the transverse guide 131 and the first guide member 118 is engaged with the transverse guide 131. The first guide member 118 is thus capable of transitioning from sliding within the longitudinal guide 132 to sliding within the transverse guide 131. This transition ‘unlocks’ the degree of freedom to turn/rotate the table 102 clockwise or anti-clockwise about the second guide member 120. When the table 102 is turned about the second guide member 120, the transverse guide 131 slides relative to the first guide member 118. In use, the first guide member 118 may transition to the transverse guide 131 when the table reaches the second position P2 so that the first guide member 118 and the transverse guide 131 are slidable relative to each other to enable the horizontal rotation of the table.

In order to limit the amount of rotation so that the table 102 (with its deployable leaves 146, 148 in the open configuration) does not collide with the front seats, the table system 100 may comprise rotation detents 124, 126 and/or a rotation limiter, both of which are illustrated in FIG. 10.

The angular separation between the first operating angle A1 (first rotation detent 124) and the second position P2 may be a value less than 70 degrees, such as approximately 30 degrees. The angular separation between the second operating angle A2 (second rotation detent 126) and the second position P2 may be a value less than 70 degrees, such as approximately 30 degrees. In a non-limiting implementation, the table 102 can be turned by +30 degrees.

In other embodiments, the transverse guide 131 may not be curved or may have a centre of curvature that is not equal to the distance separating the first guide member 118 and the second guide member 120. In these circumstances, it may be appreciated that as the first guide member 118 slides within the transverse guide 131, the second guide member may additionally slide within the longitudinal guide 132.

FIG. 10 further illustrates rotation detents 124, 126 for holding the table 102 at the limit of rotation. The pivot 108 may comprise a first detent 124 of the rotation detents 124, 126, corresponding to a first transverse guide end 136 of the transverse guide slot and corresponding to the first operating angle A1 of the table 102. The pivot 108 may comprise a second detent 126 of the rotation detents 124, 126, corresponding to a second transverse guide end 138 of the transverse guide 131 and corresponding to the second operating angle A2 of the table 102.

The rotation detents 124, 126 may comprise sockets to either side of the socket of the second detent 122. When the table 102 is turned, the biased plug may disengage from the second position detent 122 and can then engage with either one of the rotation detents 124, 126. The biased plug may be mounted to the first guide member 118. In an alternative example, detents 122, 124, 126 could be implemented using separate plugs rather than separate sockets. It is appreciated that detents 122, 124 and 126 form a detent arrangement 128, in which the detent arrangement 128 is configured to hold the table in at least one orientation. The detent arrangement 128 may hold the table 102 in at least one orientation when the table 102 is rotated around the vertical axis.

It is also appreciated that the arrangement of the longitudinal guide 132 and the transverse guide 131 comprises a table sliding interlock. This is because when the table is at the second position P2, the table may only be slid to the first (forward) position P1 when the first guide member 118 is at the intersection 133 between the longitudinal guide 132 and the transverse guide 131. This is because the first guide member 118 would otherwise be constrained to slide solely within the transverse guide 131, and would not slide within longitudinal guide 132, as is required to enable the table to slide to the first position P1.

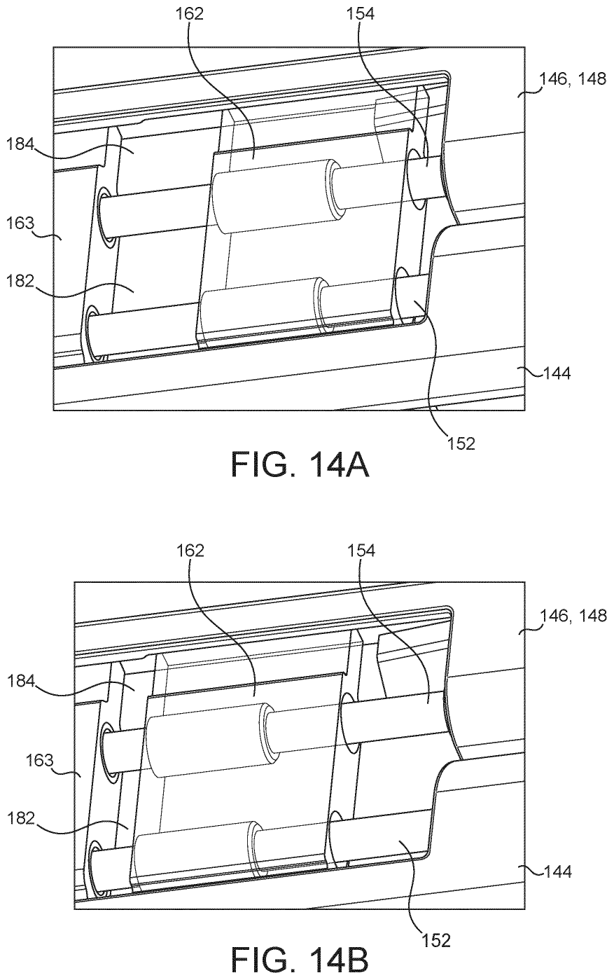

FIGS. 12A, 12B, 13A, 13B, 14A and 14B illustrate an example of an interlock 160. The interlock 160 is a rotational interlock and prevents rotation of the at least one table leaf 146, 148 relative to the table body 144 of the table 102 when the table body is at the first position P1, and permits rotation of the at least one table leaf 146, 148 relative to the table body 144 when the table body 144 is in the second position P2.

The interlock 160 may comprise a mechanical interlock 160. Alternatively, the interlock 160 may be a different type, e.g., an electromagnetic interlock. In a first embodiment, the interlock 160 may be actuated by the movement of the table body 144 from the first position P1 to the second position P2 offset from the first position. At least one interlock 160 may be provided for each of the at least one table leaves 146, 148. The interlock 160 acts to permit or prevent the rotation of the double hinge 150, wherein each of the at least one deployable table leaves 146, 148 is rotatably connected to the table body by at least one double hinge 150. The interlock 160 comprises a locking block 162 that is slidable along the first hinge axis 152 and the second hinge axis 154. The locking block 162 is constrained to move along the first hinge axis 152 and second hinge axis 154, in dependence upon the position of the table body 144 relative to the support 110. The locking block 162 may comprise a first protrusion 164, and a second protrusion 166. The first protrusion 164 and second protrusion 166 may protrude in opposing directions, in a plane intersecting the first hinge axis 152 and the second hinge axis 154.

The first protrusion 164 of the locking block 162 is configured to slide in a first guide slot 172, formed in an edge of the table body 144. The first guide slot 172 comprises a locking portion 172a and an unlocking portion 172b. The axis of the first guide slot 172, along which the first protrusion 164 slides, may be parallel to the first hinge axis 152. The locking portion 172a and the unlocking portion 172b of the first guide slot 172 are co-axial and adjacent.

When the first protrusion 164 of the locking block 162 is aligned with the locking portion 172a, the locking block 162 is at a locking position 167 and the double hinge body 156 is unable to rotate about the first hinge axis 152.

When the first protrusion 164 of the locking block 162 is aligned with the unlocking portion 172b, the locking block 162 is at an unlocking position 168 and the double hinge body 156 is able to rotate about the second hinge axis 152.

The second protrusion 166 of the locking block 162 is configured to slide in a second guide slot 174, formed in an edge of the table leaf 146, 148. The second guide slot 174 comprises a locking portion and an unlocking portion. The axis of the second guide slot 174, along which the second protrusion 166 slides, may be parallel to the second hinge axis 154. The locking portion and the unlocking portion of the second guide slot 174 are co-axial and adjacent.

When the second protrusion 166 of the locking block is aligned with the locking portion, the locking block 162 is at a locking position 167 and the double hinge body 156 is unable to rotate about the second hinge axis 154. When the second protrusion 166 of the locking block 162 is aligned with the unlocking portion, the locking block 162 is at the unlocking position 168 and the double hinge body 156 is able to rotate about the second hinge axis 154. Thus, the locking portion 172a of the first guide slot 172 and the locking portion of the second guide slot 174 correspond to a locking position 167 of the locking block 162, and the unlocking portion 172b of the first guide slot and the unlocking portion of the second guide slot 174 correspond to an unlocking position 168 of the locking block 162.

A first opening 182 is provided in the first guide slot 172 at the unlocking portion 172b. The first opening 182 is in the side of the first guide slot 172 that is closer to a longitudinal centre-line of the table. A second opening 184 is provided in the second guide slot 174 at the unlocking portion. The second opening 184 is in the side of the second guide slot 174 that is closer to a longitudinal centre-line of the table. The first opening 182 is larger than the first protrusion 164 and the second opening 184 is larger than the second protrusion 166. The locking block 162 is slidable along the first hinge axis 152 and the second hinge axis 154 such that the first protrusion 164 is aligned with the first opening 182 and the second protrusion 166 is aligned with the second opening 184.

Rotation of the first protrusion relative to the first guide slot is no longer prevented, but is instead, permitted. This is possible because the locking block 162 may rotate about the first hinge axis 152 and move into the first opening 182, and the locking block 162 may rotate about the second hinge axis 154 and move into the second opening 184. The locking block 162 is therefore rotatably disengageable from the first guide slot 172 and is rotatably disengageable from the second guide slot 174.

This permits the deployable table leaves 146, 148 to be rotated from the stowed configuration to the deployed configuration. The at least one table leaves 146, 148 may be rotated through an angle of 180°, such that before rotation, the undersides of the table leaves 146, 148 face upwards, and after rotation, the undersides of the table leaves 146, 148 face downwards.

In FIGS. 13A and 13B, the interlock 162 is shown to be slidable from the locking position to the unlocking position. This is caused by sliding the table body 144 from the first position P1 to the second position P2.

Sliding of the table body 144 relative to the support 110 causes the locking member 162 to slide along the first and second hinge axis 152, 154. Sliding of the table body from the first position P1 to the second position P2 offset from the first position P1 causes the locking member 162, comprising the first protrusion 164 and second protrusion 166 to slide from the locking position to the unlocking position, permitting the table leaves 146, 148 to be deployed.

An actuation mechanism, as now described, is provided. The actuation mechanism is configured to slide the locking block 162 from the locking position to the unlocking position in dependence on movement of the table body 144 into the second position P2.

A plate 111 is fixedly connected to the top 117 of the support 110. In some embodiments, the plate 111 may be integral with the support.

The table body 144 may comprise an internal cavity. The plate 111 may lie within the internal cavity.

A lever 190 may be provided within the internal cavity of the table body 144. The lever 190 is pivotably attached to a wall of the internal cavity by an attachment point. Thus, as the table body slides, the attachment point and the lever 190 move with the table body. The lever 190 is pivotable in a plane of the table body, for example, a horizontal plane.

The lever 190 has an input end 192 an output end 194, and a fulcrum 195 in-between. The input end 192 of the lever 190 is configured to be actuated by a portion of the support as the table body 144 slides relative to the support. For example, as the table body 144 slides relative to the support, contact may occur between the lever input end 192 and the portion of the support 110, causing the lever 190 to pivot about its axis. The portion of the support 110 may be the plate 111. The output end 194 of the lever 190 is configured to actuate the locking block 162. In some embodiments, the output end 194 of the lever 190 may be configured to push against a first end of the locking block 162. The pushing of the output end 194 of the lever 190 on the first end of the locking block 162 creates a force with a component that is aligned along the first hinge axis 152 and the second hinge axis 154. As the locking block 162 is slidable along the first hinge axis 152 and the second hinge axis 154, the pushing of the output end 194 of the lever 190 causes the locking block 162 to slide along the first hinge axis 152 and the second hinge axis 154.

A lever bias member 193 may be provided to bias the orientation of the lever to a particular orientation. For example, the lever bias member 193 may be configured to bias the output end of the lever away from the locking block 162. Alternatively, the lever bias member 193 may be configured to bias the output end of the lever towards the locking block 162. The lever bias member 193 is therefore configured to rotate the lever 190 about the lever fulcrum 195. The lever bias member 193 may be a spring, for example a leaf spring, a hair spring or a helical spring. Alternatively, the lever bias member 193 may be a spring arrangement, comprising a plurality of springs. A resilient bias 196 may be provided to generate a force to partially oppose the pushing force of the output end of the lever on the locking block 162. The resilient bias 196 acts on a second end of the locking block, opposing the first end of the locking block, and acts to slide the locking block 162 from the locking block unlocking position 168 to the locking block locking position 167. The resilient bias 196 is therefore a locking block bias member, as it biases the position of the locking block towards to the locking block locking position. The resilient bias 196 may be preloaded such that a force is generated by the resilient bias on the second end of the locking block 162 irrespective of whether the locking block 162 is in the locking position 167 or the unlocking position 168. For example, the resilient bias 196 may comprise at least one helical spring, acting along the first hinge axis 152 and/or second hinge axis 154. In this case, the at least one helical spring may be pre-compressed. A reaction member, 163, may be provided to react the force generated by the resilient bias.

It will be appreciated that to slide the table body 144 from the first position to a second position offset from the first position requires frictional forces, for example, frictional forces associated with the slider arrangement 106 to be overcome.

The resilient bias 196 is selected such that the range of forces generated by the resilient bias 196 are sufficient to cause the locking block 162 to slide along the first hinge axis 152 and the second hinge axis 154, but are insufficient to cause the table body to slide from the second position P2. Thus, when the table body 144 slides to the second position, offset from the first position, the reaction force of the resilient bias 196 increases due to rotation of the lever 190 and sliding of the locking block 162 along the first hinge axis 152 and second hinge axis 154 from the locking position to the unlocking position. However, the resilient bias 196 may only cause the locking block 162 to reset from the unlocking position to the locking position when the table body 144 slides from the second position P2 to the first position P1.

In an alternative embodiment (not illustrated), a resilient bias 196 may not be present, with the output end of the lever configured to move the locking block in either direction.

It can be appreciated that under some circumstances it may be desirable to prevent the table body from sliding from the second position, offset from the first position, while the at least one table leaves 146, 148 are deployed. This is because although the deployment of the table leaves 146, 148 is desirable in that it increase the area of the table 102, when the table is fitted to a vehicle 1 (as part of a vehicle centre console table) the width of the table may be greater than the lateral separation (y-axis separation) between the front seats.

In some embodiments a second interlock 260 may therefore be provided, wherein the second interlock prevents horizontal sliding of the table body 144 from the second position to the first position when the table leaves 146, 148 are deployed. The second interlock 260 may interact with the interlock 160, as is now described. The second interlock 260 comprises a sliding member 262 that is slidable between an interference position that is configured to prevent the horizontal sliding of the table body, and a non-interference position that is configured to prevent the horizontal sliding of the table body 144.

The sliding member 262 may slide about an axis that is in the plane of the table body 144. The axis of sliding of the sliding member 262 may have a component that is perpendicular to the axis of sliding of the table body 144. The sliding member 262 may be slidable within the internal cavity formed between the upper portion of the table body and the lower portion of the table body. The sliding member 262 has an interference end 267 and a profiled end 268. When the sliding member is at the interference position, the interference end 267 of the sliding member 262 is configured to protrude in a path of a slot 269 in the portion of the support 110. For example, the interference end of the sliding member may engage with the plate 111. The interference end 267 of the sliding member may only engage with the plate 111 when the table body is in the second position P2, horizontally offset from the first position P1. When the sliding member 262 is at the non-interference position, the profiled end 268 of the sliding member 262 is configured to at least partially occupy the first opening 182 of the first guide slot 172 formed in the edge of the table body 144. When at the non-interference position, the profiled end 268 of the sliding member 262 does not protrude into the first guide slot 172. Hence, the presence of the sliding member 262 at the non-interference position does not prevent the locking block 162 sliding along the first hinge axis and the second hinge axis to the unlocking position.

The second interlock 260 may additionally comprise at least one sliding member bias member (not shown). The sliding member bias member may be a helical spring, a leaf spring or an elastomeric component. The sliding member bias member is configured to bias the sliding member 262 away from the interference position to the non-interference position. The purpose of the sliding member bias member is therefore to disengage the interference end 267 of the sliding member 262 from the slot or socket 269 in the portion of the support 110, permitting sliding of the table body.

The surface profiles of the first protrusion 164 and profiled end 268 of the sliding member are such that sliding contact is permitted between the first protrusion 164 and the profiled end 268. The surface profiles of the first protrusion and profiled end of the sliding member may define a cam arrangement.

As rotation of the table leaves 146, 148 from the stowed position to the deployed position progresses, the penetration of the first protrusion 164 into the first opening in the first guide slot increases, with sliding contact between the first protrusion 164 and the profiled end 268. This contact causes the sliding member 262 to slide from the non-interference position towards the interference position. When the table leaves are in the deployed position, the sliding member 262 is at the interference position, with the interference end 267 engaged in the slot or socket 269 of the portion of the support 110. Sliding of the table body 144 relative to the support 110 is therefore prevented.

If the table leaves 146, 148 are then rotated from the deployed configuration to the stowed configuration, the resulting rotation of the locking block 162 about the first hinge axis 152, removes the first protrusion 164 of the locking block from the first opening provided in the first guide slot. The sliding member bias member (such as at least one helical spring) then slides the sliding member 262 away from the interference position, removing the interference end 267 of the sliding member 262 from mechanical engagement with a slot 269 or socket 269. This permits the table body 144 and deployed table leaves to be slid from the second position P2 towards the first position P1 (i.e., when installed in a vehicle 1, to be slid from an aft position to a forward position).

Although in above examples, it has been described how the second interlock may be located within an internal cavity of the table body 144, is its appreciated that in alternative embodiments, there is no internal cavity, with the second interlock located on a lower surface of the table body 144. It will be appreciated that various changes and modifications can be made to the present invention without departing from the scope of the present application. Although embodiments of the present invention have been described in the preceding paragraphs with reference to various examples, it should be appreciated that modifications to the examples given can be made without departing from the scope of the invention as claimed. For example, when at the second position, horizontally offset from the first position, the table body 144 may be configured to slide in a lateral (y-axis), rather than rotate in a horizontal plane.

Features described in the preceding description may be used in combinations other than the combinations explicitly described. Although features and/or functions have been described with reference to certain features, those features and/or functions may be performable by other features whether described or not

1. A vehicle centre console table system, the vehicle centre console table system comprising:
a table; and
a slider arrangement configured to enable horizontal sliding of the table from a first position to a second position horizontally offset from the first position;
wherein the slider arrangement is configured to prevent horizontal rotation of the table when the table is not in the second position and configured to permit horizontal rotation of the table when the table is in the second position; and
wherein the slider arrangement comprises:
a longitudinal guide arranged on a longitudinal axis of the vehicle centre console table system and comprising a first longitudinal guide end and a second longitudinal guide end; and
a transverse guide arranged transverse to the longitudinal axis and comprising a first transverse guide end to a first side of the longitudinal guide and a second transverse guide end to a second side of the longitudinal guide, wherein the transverse guide enables the horizontal rotation of the table between the first transverse guide end and the second transverse guide end while the table is at the second position.

2. (canceled)

3. The vehicle centre console table system as claimed in claim 1, wherein the slider arrangement comprises an intersection between the longitudinal guide and the transverse guide at the first longitudinal guide end of the longitudinal guide.

4. The vehicle centre console table system as claimed in claim 3, wherein the transverse guide comprises a curve to enable the horizontal rotation of the table.

5. The vehicle centre console table system as claimed in claim 1, wherein the vehicle centre console table system comprises a first guide member configured to interface with the longitudinal guide and the transverse guide, wherein the first guide member and the longitudinal guide are slidable relative to each other, and wherein the first guide member is able to transition to the transverse guide when the table reaches the second position so that the first guide member and the transverse guide are slidable relative to each other to enable the horizontal rotation of the table.

6. The vehicle centre console table system as claimed in claim 5, wherein the vehicle centre console table system comprises a second guide member configured to interface with the longitudinal guide, wherein the second guide member and the longitudinal guide are slidable relative to each other, wherein a location of the second guide member defines a vertical axis about which the table is rotatable when the table is in the second position.

7. The vehicle centre console table system as claimed in claim 1, wherein rotation of the table around the vertical axis is constrained within an angular range based on the first transverse guide end and the second transverse guide end.

8. The vehicle centre console table system as claimed in claim 7, wherein the angular range is a value selected from a range between −30° and +30°.

9. The vehicle centre console table system as claimed in claim 7, comprising a detent arrangement configured to hold the table in at least one orientation within the angular range.

10. The vehicle centre console table system as claimed in claim 9, wherein the detent arrangement comprises a plurality of detent positions.

11. The vehicle centre console table system as claimed in claim 9, wherein the detent arrangement comprises a ball, a bias and a socket, wherein the bias provides a force to locate the ball within the socket.

12. The vehicle centre console table system as claimed in claim 5, further comprising a detent arrangement configured to hold the table in at least one orientation within an angular range based on the first transverse guide end and the second transverse guide end,
wherein rotation of the table around the vertical axis is constrained within the angular range; and
wherein the first guide member comprises the ball and the bias.

13. A vehicle centre console comprising the vehicle centre console table system of claim 1.

14. A vehicle comprising the vehicle centre console of claim 13.
